(19) United States
(12) Patent Application Publication
(10) Pub. No.: US 2010/0051055 A1
(43) Pub. Date: Mar. 4, 2010

(54) SUBSTRATE PROCESSING APPARATUS AND SUBSTRATE PROCESSING METHOD

(76) Inventor: Hiroaki Takahashi, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/508,091

(22) Filed: Jul. 23, 2009

(30) Foreign Application Priority Data
Aug. 29, 2008 (JP) 2008-221863

(51) Int. Cl. B08B 1/00; B08B 13/00; B08B 3/04; B08B 5/00

(52) U.S. Cl. 134/6; 134/157; 134/144; 134/42; 134/30; 134/26

(57) ABSTRACT

The substrate processing apparatus according to the present invention includes: a substrate rotating mechanism holding a substrate in a horizontal attitude and rotating the substrate around an axis passing through the center of the substrate; a processing liquid supply mechanism supplying a processing liquid to a central portion of the upper surface of the substrate rotated by the substrate rotating mechanism; a counter member arranged to be opposed to the upper surface of the substrate rotated by the substrate rotating mechanism; and a liquid film extending mechanism moving the counter member from a position opposed to the central portion of the substrate to a position opposed to a peripheral edge portion of the substrate in parallel with the supply of the processing liquid by the processing liquid supply mechanism and extending a liquid film of the processing liquid covering the central portion of the substrate toward the peripheral edge of the substrate due to the movement.

### BACKGROUND OF THE INVENTION

1. Field of the Invention

The present invention relates a substrate processing apparatus and a substrate processing method for processing a substrate with a processing liquid. The substrate to be processed includes a semiconductor wafer, a substrate for a liquid crystal display, a substrate for a plasma display, a substrate for an FED (Field Emission Display), a substrate for an optical disk, a substrate for a magnetic disk, a substrate for a magnetooptical disk or a substrate for a photomask, for example.

2. Description of Related Art

As the size of a substrate such as a semiconductor wafer or a glass substrate for a liquid crystal display panel is increased, a single substrate processing apparatus is increasingly employed.

The single substrate processing apparatus includes a spin chuck rotating the substrate while holding the same in a horizontal attitude and a nozzle for supplying processing liquids to the surface of the substrate, for example. The spin chuck holds the substrate while directing the surface (a processed surface) thereof upward. Further, the spin chuck rotates the substrate, so that each processing liquid is supplied from the nozzle to a central portion of the surface of the substrate. The processing liquid supplied to the surface of the substrate flows on the surface of the substrate from the central portion toward the peripheral edge due to centrifugal force resulting from the rotation of the substrate.

In the steps of manufacturing a semiconductor device, a process of removing a silicon oxide film from the surface of a semiconductor wafer (hereinafter simply referred to as a “wafer”) made of silicon may be performed with a single substrate processing apparatus. In this case, HF (hydrofluoric acid) or BHF (Buffered Hydrogen Fluoride) and DIW (deionized water) are employed as processing liquids. The HF or the BHF is supplied to the surface of the wafer while the same is rotated, whereby the silicon oxide film formed on the surface of the wafer is removed.

Thereafter the DIW is supplied to the surface of the wafer while the same is kept rotated, whereby the HF or the BHF adhering to the surface of the wafer is washed out. After the washing with the DIW, the DIW is drained from the wafer by high-speed rotation of the wafer. When the wafer is dried, the series of processes for removing the silicon oxide film are terminated.

When the silicon oxide film is removed from the surface of the wafer, silicon is exposed on the surface of the wafer. The surface of silicon is hydrogen-terminated, and exhibits hydrophobicity. On the portion (where silicon is exposed) of the surface of the wafer from which the silicon oxide film has been removed, therefore, a contact angle of the processing liquid with respect to the surface is increased. Consequently, a portion not covered with the processing liquid appears on the surface of the wafer, and the wafer may be contaminated with water drops or solid foreign matter floating in the atmosphere and adhering to the portion. Particularly on a peripheral edge portion of the wafer, the centrifugal force acting on the processing liquid is so weak that the processing liquid flows in a striped manner to easily result in the portion not covered with the processing liquid.

The flow rate of the processing liquid supplied to the wafer and the rotational speed of the wafer may be increased so that the overall region of the surface of the wafer is reliably covered with the processing liquid. In this case, however, the cost required for processing each wafer is increased. Further, the processing liquid splashing from the wafer collides with members arranged around the spin chuck at a high speed, to result in a large quantity of mist of the processing liquid. The mist of the processing liquid deteriorates the dry state of the processed wafer, and adheres to the surface of the processed wafer to result in watermarks.

### SUMMARY OF THE INVENTION

An object of the present invention is to provide a substrate processing apparatus and a substrate processing method each capable of uniformly spreading a processing liquid on the overall region of the surface of a substrate without increasing the flow rate of the processing liquid supplied to the substrate and a rotational speed of the substrate.

A substrate processing apparatus according to an aspect of the present invention includes: a substrate rotating mechanism holding a substrate in a horizontal attitude and rotating the substrate around an axis passing through the center of the substrate; a processing liquid supply mechanism supplying a processing liquid to a central portion of the upper surface (the surface) of the substrate rotated by the substrate rotating mechanism; a counter member arranged to be opposed to the upper surface of the substrate rotated by the substrate rotating mechanism; and a liquid film extending mechanism moving the counter member from a position opposed to the central portion of the substrate to a position opposed to a peripheral edge portion of the substrate in parallel with the supply of the processing liquid by the processing liquid supply mechanism and extending a liquid film of the processing liquid covering the central portion of the substrate toward the peripheral edge of the substrate due to the movement.

According to the structure, the substrate rotating mechanism rotates the substrate around the axis passing through the center thereof while holding the substrate in the horizontal attitude. The processing liquid supply mechanism supplies the processing liquid to the central portion of the upper surface of the rotated substrate. Even if the upper surface of the substrate exhibits hydrophobicity, the liquid film of the processing liquid is formed at least around the position of the upper surface of the substrate supplied with the processing liquid, i.e., the central portion as long as the processing liquid supply mechanism supplies the processing liquid. On the other hand, the counter member is arranged to be opposed to the central portion of the upper surface of the substrate. Then, the counter member is moved from the position opposed to the central portion of the substrate to the position opposed to the peripheral edge portion thereof, and the liquid film of the processing liquid covering the central portion of the substrate is extended toward the peripheral edge of the substrate due to the movement. Due to the extension of the liquid film, the flow rate of the processing liquid supplied to the substrate by the processing liquid supply mechanism and the rotational speed of the substrate rotated by the substrate rotating mechanism may not be increased.

Therefore, the processing liquid can be uniformly spread on the overall region of the surface of the substrate without increasing the flow rate of the processing liquid supplied to the substrate and the rotational speed of the substrate.

A substrate processing method according to another aspect of the present invention includes: a substrate rotating step of rotating a substrate around an axis passing through the center of the substrate in a horizontal attitude; a processing liquid supplying step of supplying a processing liquid to a central portion of the upper surface of the rotated substrate; and a liquid film extending step of arranging a counter member to be opposed to the upper surface of the substrate and moving the counter member from a position opposed to the central portion of the substrate to a position opposed to a peripheral edge portion of the substrate in parallel with the processing liquid supplying step for extending a liquid film of the processing liquid covering the central portion of the substrate toward the peripheral edge of the substrate due to the movement.

The method can be carried out in the substrate processing apparatus.

The counter member may be a counter plate in the form of a plate having a lower surface parallel to the upper surface of the substrate.

In this case, the liquid film extending mechanism of the substrate processing apparatus may arrange the counter plate so that the lower surface of the counter plate is in contact with the liquid film, and may move the counter plate toward the position opposed to the peripheral edge portion of the substrate while keeping the counter plate and the liquid film in contact with each other.

In the liquid film extending step of the substrate processing method, the counter plate may be arranged so that the lower surface of the counter plate is in contact with the liquid film, and the counter plate may be moved toward the position opposed to the peripheral edge portion of the substrate while the counter plate and the liquid film are kept in contact with each other.

When the counter plate is moved while the lower surface thereof is in contact with the liquid film, the processing liquid forming the liquid film moves following the counter plate, due to the surface tension of the liquid film (the processing liquid). The substrate is rotated, whereby the processing liquid in contact with the lower surface of the counter plate swirls around the liquid film when the counter plate is moved from the position opposed to the central portion of the substrate toward the position opposed to the peripheral edge portion of the substrate, thereby increasing the diameter of the liquid film. Consequently, the liquid film can be extended.

When the counter plate is employed, the counter plate preferably has a curved surface extended from the lower surface thereof toward an upstream side of the rotational direction of the substrate and convexed outward.

The counter plate moves toward the upstream side of the rotational direction of the substrate with respect to the liquid film formed on the upper surface of the substrate, due to the rotation of the substrate. When the counter plate has the curved surface, therefore, the processing liquid forming the liquid film can be smoothly brought into the space between the lower surface of the counter plate and the upper surface of the substrate along the curved surface. Therefore, the counter plate and the processing liquid can be excellently kept in contact with each other.

In order to more excellently keep the counter plate and the processing liquid in contact with each other, the surface of the counter plate in contact with the liquid film is preferably hydrophilized.

The counter member may be a porous member made of a porous material.

In this case, the liquid film extending mechanism of the substrate processing apparatus may arrange the porous member to be in contact with the liquid film, and may move the porous member toward the position opposed to the peripheral edge portion of the substrate while keeping the porous member and the liquid film in contact with each other.

In the liquid film extending step of the substrate processing method, the porous member may be arranged to be in contact with the liquid film, and the porous member may be moved toward the position opposed to the peripheral edge portion of the substrate while the porous member and the liquid film are kept in contact with each other.

When the porous member is moved while the same is in contact with the liquid film, the processing liquid forming the liquid film moves following the counter plate, due to liquid absorptivity of the porous member and the surface tension of the liquid film (the processing liquid). The substrate is rotated, whereby the processing liquid in contact with the porous member swirls around the liquid film when the porous member is moved from the position opposed to the central portion of the substrate toward the position opposed to the peripheral edge portion of the substrate, thereby increasing the diameter of the liquid film. Consequently, the liquid film can be extended.

The counter member may be a gas nozzle having a slitlike discharge port and discharging a gas from the discharge port.

In this case, the liquid film extending mechanism of the substrate processing apparatus may arrange the gas nozzle so that the gas discharged from the discharge port is sprayed on the liquid film, and may move the gas nozzle toward the position opposed to the peripheral edge portion of the substrate while keeping a surface layer portion of the liquid film crushed by the gas.

In the liquid film extending step of the substrate processing method, the gas nozzle may be arranged so that the gas discharged from the discharge port is sprayed on the liquid film, and the gas nozzle maybe moved toward the position opposed to the peripheral edge portion of the substrate while the surface layer portion of the liquid film is kept crushed by the gas.

When the gas nozzle is moved while the surface layer portion of the liquid film is crushed by the gas discharged from the gas nozzle, i.e., while the surface of the liquid film formed by surface tension is partially collapsed by the gas discharged from the gas nozzle, the processing liquid flows toward the peripheral edge of the substrate from the collapsed portion. The substrate is rotated, whereby the processing liquid flowing from the liquid film swirls around the liquid film when the gas nozzle is moved from the position opposed to the central portion of the substrate toward the position opposed to the peripheral edge portion of the substrate, thereby increasing the diameter of the liquid film. Consequently, the liquid film can be extended.

The counter member may be a processing liquid nozzle discharging a processing liquid of the same type as the processing liquid supplied by the processing liquid supply mechanism.

In this case, the liquid film extending mechanism of the substrate processing apparatus may arrange the processing liquid nozzle so that the processing liquid discharged from the processing liquid nozzle is sprayed on the liquid film, and may move the processing liquid nozzle toward the position opposed to the peripheral edge portion of the substrate while keeping a surface layer portion of the liquid film crushed by the processing liquid discharged from the processing liquid nozzle.

In the liquid film extending step of the substrate processing method, the processing liquid nozzle may be arranged so that the processing liquid discharged from the processing liquid nozzle is sprayed on the liquid film, and the processing liquid nozzle may be moved toward the position opposed to the peripheral edge portion of the substrate while the surface layer portion of the liquid film is kept crushed by the processing liquid discharged from the processing liquid nozzle.

When the processing liquid nozzle is moved while the surface layer portion of the liquid film is crushed by the processing liquid discharged from the processing liquid nozzle, i.e., while the surface of the liquid film formed by surface tension is partially collapsed by the processing liquid discharged from the processing liquid nozzle, the processing liquid flows toward the peripheral edge of the substrate from the collapsed portion. The substrate is rotated, whereby the processing liquid flowing from the liquid film swirls around the liquid film when the processing liquid nozzle is moved from the position opposed to the central portion of the substrate toward the position opposed to the peripheral edge portion of the substrate, thereby increasing the diameter of the liquid film. Consequently, the liquid film can be extended.

The foregoing and other objects, features and effects of the present invention will become more apparent from the following detailed description of the embodiments with reference to the attached drawings.

### BRIEF DESCRIPTION OF THE DRAWINGS

FIG. 1 is a sectional view schematically showing the structure of a substrate processing apparatus according to an embodiment of the present invention.

FIG. 2 is a perspective view of a counter plate shown in FIG. 1.

FIG. 3A is a schematic side elevational view showing a processing state (a state where the counter plate is not opposed to a substrate) of the substrate processing apparatus.

FIG. 3B is a schematic side elevational view showing another processing state (a state where the counter plate is in contact with a liquid film) of the substrate processing apparatus.

FIG. 3C is a schematic side elevational view showing still another processing state (a state where the liquid film is extended) of the substrate processing apparatus.

FIG. 4 is a perspective view schematically showing the structure of a gas nozzle as another example of the counter member.

FIG. 5 is a plan view schematically showing a structure employing a twist member as still another example of the counter member.

FIG. 6 is a plan view schematically showing a structure employing a disc member (a porous member) as a further example of the counter member.

FIG. 7 is a sectional view schematically showing a structure of the substrate processing apparatus employing a processing liquid nozzle as a further example of the counter member.

### DETAILED DESCRIPTION OF PREFERRED EMBODIMENTS

An embodiment of the present invention is now described in detail with reference to the attached drawings.

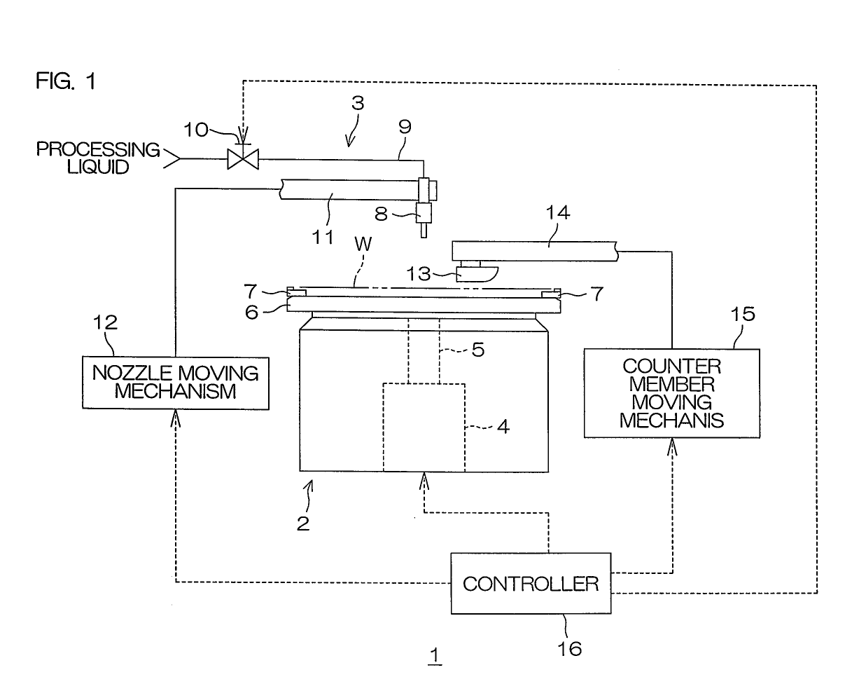

FIG. 1 is a sectional view schematically showing the structure of a substrate processing apparatus according to the embodiment of the present invention.

A substrate processing apparatus 1 includes a wafer rotating mechanism 2 for rotating a wafer W as an example of a substrate while holding the same in a generally horizontal attitude and a processing liquid supply mechanism 3 for supplying processing liquids to the upper surface (the surface) of the wafer W held by the wafer rotating mechanism 2.

The wafer rotating mechanism 2 is a nipping type mechanism, for example. More specifically, the wafer rotating mechanism 2 includes a motor 4, a spin shaft 5 integrated with a driving shaft of the motor 4, a discoidal spin base 6 generally horizontally mounted on the upper end of the spin shaft 5 and a plurality of nipping members 7 provided on a plurality of portions of the peripheral edge portion of the spin base 6 at generally regular intervals.

The wafer W can be nipped by the plurality of nipping members 7 in the generally horizontal attitude. When the motor 4 is driven in this state, the wafer W is rotated around the central axis of the spin shaft 5 along with the spin base 6 due to the driving force of the motor 4, while keeping the generally horizontal attitude.

The processing liquid supply mechanism 3 includes a nozzle 8, a supply pipe 9 connected to the nozzle 8 and a valve 10 interposed in an intermediate portion of the supply pipe 9.

The nozzle 8 is mounted on the forward end portion of an arm 11. The arm 11 horizontally extends above the wafer rotating mechanism 2. A nozzle moving mechanism 12 including a motor and the like is coupled to the arm 11. The nozzle moving mechanism 12 can swing the arm 11 in a horizontal plane around an axis set on a side portion of the wafer rotating mechanism 2. Following the swinging of the arm 11, the nozzle 8 horizontally moves above the wafer rotating mechanism 2.

The supply pipe 9 is supplied with the processing liquids from processing liquid sources (not shown). When the valve 10 is opened, each processing liquid supplied to the supply pipe 9 is supplied from the supply pipe 9 to the nozzle 8, which in turn discharges the processing liquid downward.

A counter plate 13 as an example of a counter member is provided above the wafer rotating mechanism 2. The counter plate 13 is mounted on the forward end portion of an arm 14 horizontally extending above the wafer rotating mechanism 2. A counter member moving mechanism 15 including a motor and the like is coupled to the arm 14. The counter member moving mechanism 15 can swing the arm 14 in a horizontal plane around an axis set on a side portion of the wafer rotating mechanism 2. The arm 14 is arranged on a position where the swinging locus thereof does not overlap with the swinging locus of the arm 11 in the vertical direction and the horizontal direction, in order to avoid interference with the arm 11. Following the swinging of the arm 14, the counter plate 13 horizontally moves above the wafer rotating mechanism 2. The counter member moving mechanism 15 can vertically move the arm 14. The counter plate 13 is vertically moved following the vertical movement of the arm 14.

When processing the wafer W, the counter plate 13 is arranged on a position opposed to the upper surface of the wafer 13.

The substrate processing apparatus 1 further includes a controller 16 constituted of a microcomputer. The controller 16 controls driving of the motor 4, the nozzle moving mechanism 12 and the counter member moving mechanism 15 and controls opening/closing of the valve 10 according to predetermined programs.

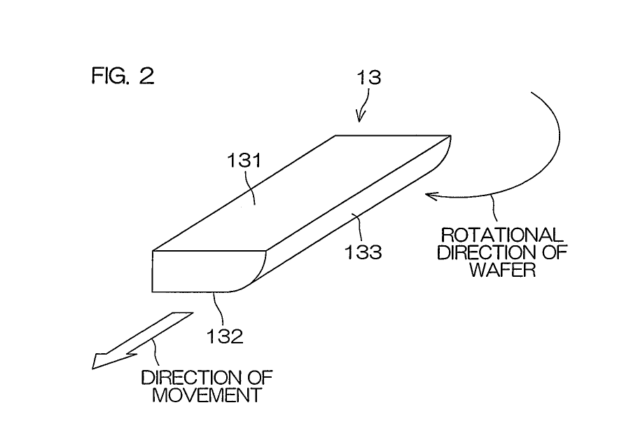

FIG. 2 is a perspective view schematically showing the structure of the counter plate 13.

The counter plate 13 is made of quartz, vinyl chloride or PTFE (polytetrafluoroethylene). The counter plate 13 is generally in the form of a rectangular plate, and has upper and lower surfaces 131 and 132 rectangular in plan view. The size of the lower surface 132 in the width direction orthogonal to the longitudinal direction is smaller than that of the upper surface 131. A width-directional first edge of the lower surface 132 overlaps with a width-directional first edge of the upper surface 131 in the vertical direction. On the other hand, a width-directional second edge of the lower surface 132 deviates from a width-directional second edge of the upper surface 131 in the width direction. A curved surface 133 convexed outward is formed between the second edge of the lower surface 132 and the second edge of the upper surface 131.

The overall surfaces of the counter plate 13 are hydrophilized for reducing a contact angle of each processing liquid. The surfaces of the counter plate 13 can be hydrophilized by surface irregularization (surface roughening) by polishing or etching, for example.

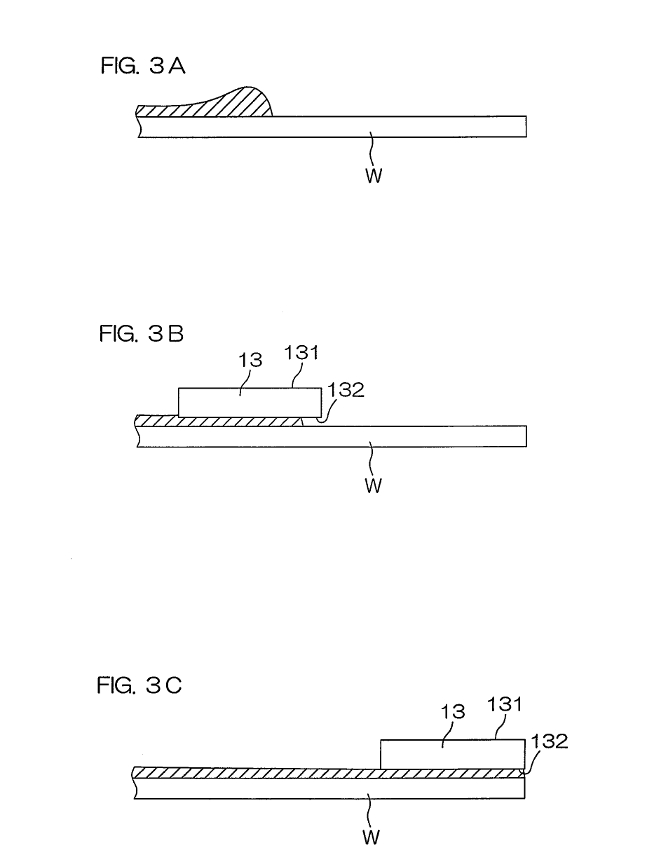

FIGS. 3A to 3C are schematic side elevational views showing processing states in the substrate processing apparatus 1.

The substrate processing apparatus 1 is employed for a process of removing a silicon oxide film from the surface of thewafer W, for example. In this case, HF and DIW are employed as the processing liquids. The HF may be replaced with BHF. Operations of the respective portions of the substrate processing apparatus 1 are now described with reference to the process of removing the silicon oxide film with the HF and the DIW.

The wafer rotating mechanism 2 holds the wafer W while directing the surface provided with the silicon oxide film upward. When the wafer rotating mechanism 2 holds the wafer W, the motor 4 is driven to start rotating the wafer W. On the other hand, the nozzle moving mechanism 12 moves the nozzle 8 to a position opposed to a central portion of the wafer W held by the wafer rotating mechanism 2.

When the nozzle 8 is completely moved, the valve 10 is opened, and the HF supplied to the supply pipe 9 as the processing liquid is supplied from the nozzle 8 to the central portion of the upper surface (the surface) of the wafer W rotated at a prescribed rotational speed (300 rpm, for example). The HF supplied to the upper surface of the wafer W forms a liquid film at least covering the central portion to which the same is supplied.

As shown in FIG. 3A, a peripheral edge portion of the liquid film of the HF swells upward beyond a central side thereof, due to surface tension and the action of centrifugal force resulting from the rotation of the wafer W.

FIGS. 3A to 3C show the liquid film in a hatched manner, in order to facilitate easy understanding of the illustrations.

In time with the start of the supply of the HF, the counter member moving mechanism 15 moves the counter plate 13 to a position opposed to the liquid film formed on the upper surface of the wafer W. When the movement is completed, the longitudinal direction of the counter plate 13 is along the direction of the radius of rotation of the wafer W, and the curved surface 133 (see FIG. 2) is directed to an upstream side of the rotational direction of the wafer W. Thereafter the counter plate member moving mechanism 15 approaches (lowers) the counter plate 13 to the upper surface of the wafer W, and brings the lower surface 132 of the counter plate 13 into contact with the liquid film formed on the central portion of the upper surface of the wafer W. Then, the HF forming the liquid film enters the space between the lower surface 132 of the counter plate 13 and the upper surface of the wafer W due to the surface tension thereof, as shown in FIG. 3B. At this time, the curved surface 133 of the counter plate 13 is directed to the upstream side of the rotational direction of the wafer W, whereby the HF smoothly enters the space between the lower surface 132 of the counter plate 13 and the upper surface of the wafer W. Also due to the hydrophilization of the lower surface 132 and the curved surface 133 of the counter plate 13, the HF is guided along the curved surface 133 to smoothly enter the space between the lower surface 132 of the counter plate 13 and the upper surface of the wafer W.

Thereafter the counter member moving mechanism 15 horizontally moves the counter plate 13 toward a position opposed to the peripheral edge portion of the wafer W while the HF is continuously supplied to the upper surface of the wafer W. When the counter plate 13 is moved, the HF forming the liquid film moves following the counter plate 13, due to the surface tension of the liquid film (HF). The wafer W is rotated, whereby the HF in contact with the lower surface 132 of the counter plate 13 swirls around the liquid film when the counter plate 13 is moved from the position opposed to the central portion of the wafer W toward the position opposed to the peripheral edge portion of the wafer W, thereby increasing the diameter of the liquid film. The speed for moving the counter plate 13 is set to 5 cm/sec., for example, so that the HF does not separate from the lower surface 132 of the counter plate 13. The counter plate 13 has the curved surface 133 while the curved surface 133 and the lower surface 132 are hydrophilized, whereby the lower surface 132 of the counter plate 13 and the HF are excellently kept in contact with each other also when the counter plate 13 is moved.

When the counter plate 13 is moved up to the position opposed to the peripheral edge portion of the wafer W as shown in FIG. 3C, the counter plate 13 is stopped on the position opposed to the peripheral edge portion while the lower surface 132 thereof is kept in contact with the liquid film. Thus, the overall region of the upper surface of the wafer W is kept covered with the liquid film of the HF, and the silicon oxide film is excellently removed from the upper surface of the wafer W due to an etching action of the HF.

When a prescribed time (30 seconds, for example) elapses from the supply of the HF, the valve 10 is closed, to stop supplying the HF. Then, the counter member moving mechanism 15 temporarily moves the counter plate 13 to a position deviating from the upper portion of the wafer W.

Thereafter the valve 10 is opened, and the DIW supplied to the supply pipe 9 as the processing liquid is supplied from the nozzle 8 to the central portion of the upper surface (the surface) of the rotated wafer W. The DIW supplied to the upper surface of the wafer W forms a liquid film at least covering the central portion to which the same is supplied.

The substrate processing apparatus 1 may be provided with two processing liquid supply mechanisms 3, so that one of the processing liquid supply mechanisms 3 is employed for supplying the HF and the other processing liquid supply mechanism 3 is employed for supplying the DIW.

As shown in FIG. 3A, a peripheral edge portion of the liquid film of the DIW swells upward beyond a central side thereof, due to surface tension and the action of centrifugal force resulting from the rotation of the wafer W. Hydrogen-terminated silicon is exposed on the surface of the wafer W, due to the removal of the silicon oxide film. The surface of the wafer W exposing silicon exhibits hydrophobicity. Therefore, the liquid film of the DIW particularly remarkably swells on the peripheral edge portion thereof, and the contact angle of the liquid film (DIW) with respect to the surface of the wafer W is not less than 70°.

Thereafter the counter member moving mechanism 15 moves the counter plate 13 to the position opposed to the liquid film formed on the upper surface of the wafer W similarly to the operation of supplying the HF, and brings the lower surface 132 of the counter plate 13 into contact with the liquid film formed on the central portion of the upper surface of the wafer W, as shown in FIG. 3B. The counter member moving mechanism 15 horizontally moves the counter plate 13 toward the position opposed to the peripheral edge portion of the wafer W while the DIW is continuously supplied to the upper surface of the wafer W. When the counter plate 13 is moved, the DIW forming the liquid film moves following the counter plate 13, due to the surface tension of the liquid film (DIW). The wafer W is rotated, whereby the DIW in contact with the lower surface 132 of the counter plate 13 swirls around the liquid film when the counter plate 13 is moved from the position opposed to the central portion of the wafer W toward the position opposed to the peripheral edge portion of the wafer W, thereby increasing the diameter of the liquid film. The speed for moving the counter plate 13 is set to 5 cm/sec., for example, so that the DIW does not separate from the lower surface 132 of the counter plate 13. The counter plate 13 has the curved surface 133 while the curved surface 133 and the lower surface 132 are hydrophilized, whereby the lower surface 132 of the counter plate 13 and the DIW are excellently kept in contact with each other also when the counter plate 13 is moved.

When the counter plate 13 is moved up to the position opposed to the peripheral edge portion of the wafer W as shown in FIG. 3C, the counter plate 13 is stopped on the position opposed to the peripheral edge portion while the lower surface 132 thereof is in contact with the liquid film. Thus, the overall region of the upper surface of the wafer W is kept covered with the liquid film of the DIW. The DIW is continuously supplied to the upper surface of the wafer W, whereby the DIW flows down from the peripheral edge of the wafer W along with the HF having adhered to the wafer W while keeping the liquid film. Consequently, the HF is replaced with the DIW in the liquid film, and the HF is removed from the upper surface of the wafer W.

When the prescribed time (30 seconds, for example) elapses from the start of the supply of the DIW, the valve 10 is closed, to stop supplying the DIW. Thereafter the nozzle moving mechanism 12 and the counter member moving mechanism 15 move the nozzle 8 and the counter plate 13 to positions deviating from the upper portion of the wafer W respectively. Then, the wafer W is rotated at a high speed for draining the DIW adhering to the wafer W, and the series of processes for removing the silicon oxide film are terminated when the wafer W is dried.

As hereinabove described, the processing liquid (the HF or the DIW) is supplied from the nozzle 8 to the central portion of the upper surface of the rotated wafer W. Even if the upper surface of the wafer W exhibits hydrophobicity, the liquid film of the processing liquid is formed at least around the position of the upper surface of the wafer W supplied with the processing liquid, i.e., the central portion, as long as the processing liquid is supplied from the nozzle 8. On the other hand, the counter plate 13 is opposed to the central portion of the upper surface of the wafer W. Then, the counter plate 13 is moved from the position opposed to the central portion of the wafer W to the position opposed to the peripheral edge portion thereof, and the liquid film of the processing liquid covering the central portion of the wafer W is extended toward the peripheral edge of the wafer W due to the movement. Due to the extension of the liquid film, the flow rate of the processing liquid supplied from the nozzle 8 to the wafer W and the speed for rotating the wafer W may not be increased.

Therefore, the processing liquid can be uniformly spread on the overall region of the surface of the wafer W without increasing the flow rate of the supplied processing liquid and the speed for rotating the wafer W.

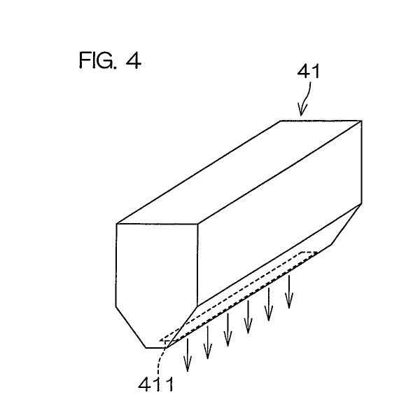

FIG. 4 is a perspective view schematically showing the structure of a gas nozzle as another example of the counter member.

A gas nozzle 41 is mounted on the forward end portion of the arm 14, in place of the counter plate 13. The gas nozzle 41 is generally in the form of a rectangular parallelepiped, and has a slitlike discharge port 411 on the lower end surface thereof. The discharge port 411 is 0.2 mm by 60 mm in size, for example. A gas passage (not shown) communicating with the discharge port 411 is formed in the gas nozzle 41. A gas is supplied to the gas passage through a gas supply pipe (not shown). The gas supplied to the gas passage is discharged downward from the discharge port 411. An inert gas such as nitrogen gas, for example, is employed as the gas.

The counter member moving mechanism 15 (see FIG. 1) moves the gas nozzle 41 to the position opposed to the liquid film (the central portion of the wafer W) formed on the upper surface of the rotated wafer W. When the movement is completed, the longitudinal direction of the discharge port 411 is along the direction of the radius of rotation of the wafer W. Thereafter the gas is discharged from the discharge port 411. Then, a surface layer portion of the liquid film is partially crushed by the gas discharged from the discharge port 411. In other words, the surface of the liquid film is partially collapsed by the gas discharged from the discharge port 411. In this state, the counter member moving mechanism 15 horizontally moves the gas nozzle 41 toward the position opposed to the peripheral edge portion of the wafer W. When the gas nozzle 41 is moved, the processing liquid flows from the collapsed portion toward the peripheral edge of the wafer W. The wafer W is rotated, whereby the processing liquid flowing out of the liquid film swirls around the liquid film when the gas nozzle 41 is moved from the position opposed to the central portion of the wafer W toward the position opposed to the peripheral edge portion of the wafer W, thereby increasing the diameter of the liquid film. Consequently, the liquid film can be extended.

Also according to the structure employing the gas nozzle 41, therefore, the processing liquid can be uniformly spread on the overall region of the surface of the wafer W without increasing the flow rate of the supplied processing liquid and the speed for rotating the wafer W, similarly to the structure employing the counter plate 13.

FIG. 5 is a plan view schematically showing a structure employing a twist member as still another example of the counter member.

A twist member 51 is generally in the form of a cylinder. A shaft 511 extending in the horizontal direction is held on the forward end portion of the arm 14, and the twist member 51 is rotatably supported on the shaft 511. A spiral groove 512 is formed on the peripheral surface of the twist member 51. The twist member 51 is made of vinyl chloride or PTFE (polytetrafluoroethylene), and the peripheral surface thereof is hydrophilized.

The counter member moving mechanism 15 (see FIG. 1) moves the twist member 51 to the position opposed to the liquid film (the central portion of the wafer W) formed on the upper surface of the rotated wafer W. When the movement is completed, the longitudinal direction (the direction of the axis of rotation) of the twist member 51 is along the direction of the radius of rotation of the wafer W. Thereafter the counter member moving mechanism 15 approaches (lowers) the twist member 51 to the upper surface of the wafer W, and brings the peripheral surface of the twist member 51 into contact with the liquid film formed on the central portion of the upper surface of the wafer W. At this time, the wafer W is rotated, whereby the processing liquid forming the liquid film enters the groove 512 of the twist member 51. The processing liquid so enters the groove 512 that the twist member 51 rotates around the shaft 511, and the processing liquid is drawn into the space between the twist member 51 and the upper surface of the wafer W due to the rotation of the twist member 51.

Thereafter the counter member moving mechanism 15 horizontally moves the twist member 51 toward the position opposed to the peripheral edge portion of the wafer W along the direction of the axis of rotation there of while the processing liquid is continuously supplied to the upper surface of the wafer W. When the twist member 51 is moved, the processing liquid forming the liquid film moves following the twist member 51, due to the surface tension of the liquid film. The wafer W is rotated, whereby the processing liquid in contact with the twist member 51 swirls around the liquid film when the twist member 51 is moved from the position opposed to the central portion of the wafer W toward the position opposed to the peripheral edge portion of the wafer W, thereby increasing the diameter of the liquid film. Consequently, the liquid film can be extended. The twist member 51 is rotated and the peripheral surface of the twist member 51 is hydrophilized, whereby the peripheral surface of the twist member 51 and the processing liquid are excellently kept in contact with each other also when the twist member 51 is moved.

Also according to the structure employing the twist member 51, therefore, the processing liquid can be uniformly spread on the overall region of the surface of the wafer W without increasing the flow rate of the supplied processing liquid and the speed for rotating the wafer W, similarly to the structure employing the counter plate 13.

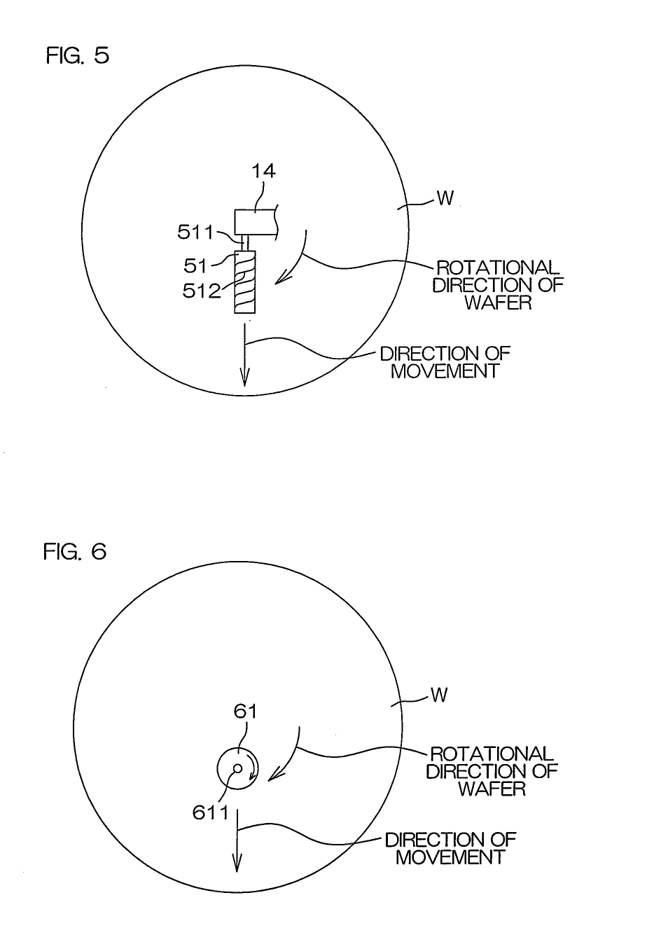

FIG. 6 is a plan view schematically showing a structure employing a disc member as a further example of the counter member.

A disc member 61 is made of a porous material such as a sponge made of PVA (polyvinyl alcohol), PE (polyethylene), urethane or silicon, and in the form of a disc (generally in the form of a flat cylinder). A shaft 611 suspended along the vertical direction is rotatably held on the forward end portion of the arm 14, and the disc member 61 is mounted on the shaft 611. Rotational driving force from a rotational driving source (not shown) is input in the shaft 611.

The counter member moving mechanism 15 (see FIG. 1) moves the disc member 61 to the position opposed to the liquid film (the central portion of the wafer W) formed on the upper surface of the rotated wafer W. Thereafter the counter member moving mechanism 15 approaches (lowers) the disc member 61 to the upper surface of the wafer W, and brings the lower surface of the disc member 61 into contact with the liquid film formed on the central portion of the upper surface of the wafer W. The disc member 61 is rotated in the same direction as the rotational direction of the wafer W by the rotational driving force input in the shaft 611.

Thereafter the counter member moving mechanism 15 horizontally moves the disc member 61 toward the position opposed to the peripheral edge portion of the wafer W along the direction of the axis of rotation thereof while the processing liquid is continuously supplied to the upper surface of the wafer W. When the disc member 61 is moved, the processing liquid forming the liquid film moves following the disc member 61, due to water absorptivity of the porous material and the surface tension of the liquid film. The wafer W is rotated, whereby the processing liquid in contact with the disc member 61 swirls around the liquid film when the disc member 61 is moved from the position opposed to the central portion of the wafer W toward the position opposed to the peripheral edge portion of the wafer W, thereby increasing the diameter of the liquid film. Consequently, the liquid film can be extended. The lower surface of the disc member 61 is hydrophilized, whereby the lower surface of the disc member 61 and the processing liquid can be excellently kept in contact with each other also when the disc member 61 is moved.

Also according to the structure employing the disc member 61, therefore, the processing liquid can be uniformly spread on the overall region of the surface of the wafer W without increasing the flow rate of the supplied processing liquid and the speed for rotating the wafer W, similarly to the structure employing the counter plate 13.

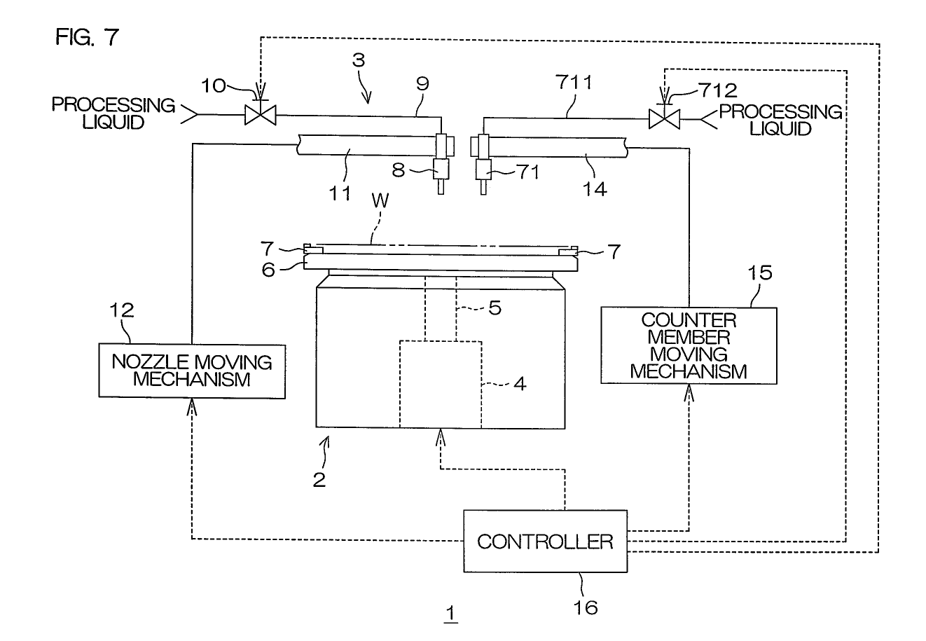

FIG. 7 is a sectional view schematically showing the structure of the substrate processing apparatus 1 employing a processing liquid nozzle as a further example of the counter member.

A processing liquid nozzle 71 is mounted on the forward end portion of the arm 14, in place of the counter plate 13. A supply pipe 711 supplied with processing liquids of the same types as the processing liquids discharged from the nozzle 8 is connected to the processing liquid nozzle 71. A valve 712 whose opening/closing is controlled by the controller 16 is interposed in the supply pipe 711.

The counter member moving mechanism 15 moves the processing liquid nozzle 71 to the position opposed to the liquid film (the central portion of the wafer W) formed on the upper surface of the rotated wafer W. Thereafter the valve 712 is opened, and either processing liquid is discharged from the processing liquid nozzle 71. Then, the surface layer portion of the liquid film is partially crushed by the processing liquid discharged from the processing liquid nozzle 71. In other words, the surface of the liquid film is partially collapsed by the processing liquid discharged from the discharge port 411. In this state, the counter member moving mechanism 15 horizontally moves the processing liquid nozzle 71 toward the position opposed to the peripheral edge portion of the wafer W. When the processing liquid nozzle 71 is moved, the processing liquid flows from the collapsed portion toward the peripheral edge of the wafer W. The wafer W is rotated, whereby the processing liquid flowing out of the liquid film swirls around the liquid film when the processing liquid nozzle 71 is moved from the position opposed to the central portion of the wafer W toward the position opposed to the peripheral edge portion of the wafer W, thereby increasing the diameter of the liquid film. Consequently, the liquid film can be extended.

Also according to the structure employing the processing liquid nozzle 71, therefore, the processing liquid can be uniformly spread on the overall region of the surface of the wafer W without increasing the flow rate of the supplied processing liquid and the speed for rotating the wafer W, similarly to the structure employing the counter plate 13.

While the embodiment of the present invention has been described, the present invention may be embodied in other ways.

For example, the substrate processing apparatus according to the present invention is not restricted to the process of removing the silicon oxide film from the surface of the substrate, but can be widely used for another process employing processing liquids. However, the effects of the present invention are particularly remarkably attained when the surface of the substrate exhibits hydrophobicity. A process of removing a resist (without employing an oxidizing processing liquid) can be illustrated as an example of the process on a substrate whose surface exhibits hydrophobicity, in addition to the process of removing the silicon oxide film.

While the present invention has been described in detail byway of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2008-221863 filed with the Japan Patent Office on Aug. 29, 2008, the disclosure of which is incorporated herein by reference.

What is claimed is:

1. A substrate processing apparatus comprising:
a substrate rotating mechanism holding a substrate in a horizontal attitude and rotating the substrate around an axis passing through the center of the substrate;
a processing liquid supply mechanism supplying a processing liquid to a central portion of the upper surface of the substrate rotated by the substrate rotating mechanism;
a counter member arranged to be opposed to the upper surface of the substrate rotated by the substrate rotating mechanism; and
a liquid film extending mechanism moving the counter member from a position opposed to the central portion of the substrate to a position opposed to a peripheral edge portion of the substrate in parallel with the supply of the processing liquid by the processing liquid supply mechanism and extending a liquid film of the processing liquid covering the central portion of the substrate toward the peripheral edge of the substrate due to the movement.

2. The substrate processing apparatus according to claim 1, wherein
the counter member is a counter plate in the form of a plate having a lower surface parallel to the upper surface of the substrate, and
the liquid film extending mechanism arranges the counter plate so that the lower surface of the counter plate is in contact with the liquid film, and moves the counter plate toward the position opposed to the peripheral edge portion of the substrate while keeping the counter plate and the liquid film in contact with each other.

3. The substrate processing apparatus according to claim 2, wherein
the counter plate has a curved surface extended from the lower surface thereof toward an upstream side of the rotational direction of the substrate and convexed outward.

4. The substrate processing apparatus according to claim 2, wherein
the surface of the counter plate in contact with the liquid film is hydrophilized.

5. The substrate processing apparatus according to claim 1, wherein
the counter member is a porous member made of a porous material, and
the liquid film extending mechanism arranges the porous member to be in contact with the liquid film, and moves the porous member toward the position opposed to the peripheral edge portion of the substrate while keeping the porous member and the liquid film in contact with each other.

6. The substrate processing apparatus according to claim 1, wherein
the counter member is a gas nozzle having a slitlike discharge port and discharging a gas from the discharge port, and
the liquid film extending mechanism arranges the gas nozzle so that the gas discharged from the discharge port is sprayed on the liquid film, and moves the gas nozzle toward the position opposed to the peripheral edge portion of the substrate while keeping a surface layer portion of the liquid film crushed by the gas.

7. The substrate processing apparatus according to claim 1, wherein
the counter member is a processing liquid nozzle discharging a processing liquid of the same type as the processing liquid supplied by the processing liquid supply mechanism, and
the liquid film extending mechanism arranges the processing liquid nozzle so that the processing liquid discharged from the processing liquid nozzle is sprayed on the liquid film, and moves the processing liquid nozzle toward the position opposed to the peripheral edge portion of the substrate while keeping a surface layer portion of the liquid film crushed by the processing liquid discharged from the processing liquid nozzle.

8. A substrate processing method comprising:
a substrate rotating step of rotating a substrate around an axis passing through the center of the substrate in a horizontal attitude;
a processing liquid supplying step of supplying a processing liquid to a central portion of the upper surface of the rotated substrate; and
a liquid film extending step of opposing a counter member to be opposed to the upper surface of the substrate and moving the counter member from a position opposed to the central portion of the substrate to a position opposed to a peripheral edge portion of the substrate in parallel with the processing liquid supplying step for extending a liquid film of the processing liquid covering the central portion of the substrate toward the peripheral edge of the substrate due to the movement.

9. The substrate processing method according to claim 8, wherein
the counter member is a counter plate in the form of a plate having a lower surface parallel to the upper surface of the substrate, and
the counter plate is arranged so that the lower surface of the counter plate is in contact with the liquid film and the counter plate is moved toward the position opposed to the peripheral edge portion of the substrate while the counter plate and the liquid film are kept in contact with each other in the liquid film extending step.

10. The substrate processing method according to claim 8, wherein
the counter member is a porous member made of a porous material, and
the porous member is arranged to be in contact with the liquid film and the porous member is moved toward the position opposed to the peripheral edge portion of the substrate while the porous member and the liquid film are kept in contact with each other in the liquid film extending step.

11. The substrate processing method according to claim 8, wherein
the counter member is a gas nozzle having a slitlike discharge port and discharging a gas from the discharge port, and
the gas nozzle is arranged so that the gas discharged from the discharge port is sprayed on the liquid film and the gas nozzle is moved toward the position opposed to the peripheral edge portion of the substrate while a surface layer portion of the liquid film is kept crushed by the gas in the liquid film extending step.

12. The substrate processing method according to claim 8, wherein
the counter member is a processing liquid nozzle discharging a processing liquid of the same type as the processing liquid forming the liquid film, and
the processing liquid nozzle is arranged so that the processing liquid discharged from the processing liquid nozzle is sprayed on the liquid film and the processing liquid nozzle is moved toward the position opposed to the peripheral edge portion of the substrate while a surface layer portion of the liquid film is kept crushed by the processing liquid discharged from the processing liquid nozzle in the liquid film extending step.
